(19) United States
(12) Patent Application Publication
(10) Pub. No.: US 2003/0235365 A1
(43) Pub. Date: Dec. 25, 2003

(54) Multistage chromatic dispersion slope compensator

(76) Inventors: Scott P. Campbell, Thousand Oaks, CA (US); Pochi A. Yeh, Thousand Oaks, CA (US)

Correspondence Address: Scot A. Reader, Esq., Suite 420, 15300 Ventura Boulevard, Sherman Oaks, CA, 91403, US

(21) Appl. No.: 10/442,033

(22) Filed: May 20, 2003

Related U.S. Application Data
(60) Provisional application No. 60/390,918, filed on Jun. 24, 2002.

(51) Int. Cl. G02B 6/26

(52) U.S. Cl. 385/27

(57) ABSTRACT

A pair of chromatic dispersion slope compensators (CDSCs) used in tandem to create a “net CDSC” having a zero-dispersion crosspoint. The paired CDSCs preferably have similar compensating dispersion slopes but opposing average compensating dispersions. The first CDSC may vary in dispersion from a large positive value to a small positive value across the operational bandwidths, while the second CDSC may vary in dispersion from a small negative value to a large negative value across the operational bandwidths. The paired CDSCs may be applied in either order to reduce the dispersion slope of chromatically dispersed light received over a transmission fiber. The CDSCs may be Gires-Tournois etalon (GTE) based.

### CROSS-REFERENCE OF RELATED APPLICATION(S)

This application claims the benefit of U.S. provisional application No. 60/ 390,918, filed on Jun. 24, 2002, the contents of which are incorporated herein by reference.

### BACKGROUND OF THE INVENTION

As more operational bandwidths are being used at higher modulation rates in telecommunication transmission fibers, signal anomalies resulting from the characteristics of such fibers need to be more accurately compensated for. One such anomaly is chromatic dispersion. In chromatic dispersion, different wavelengths of light travel at different speeds down a fiber, thereby causing light pulses encoded on such wavelengths to smear and merge together. This smearing and merging results in the inability to distinguish neighboring bits in the optical data stream at the end of transmission and, if not corrected, results in bit errors.

A common method to correct for chromatic dispersion is to reverse its effects; that is, to somehow pass the smeared and merged data pulses through a material that negates the transmission fiber's chromatic dispersion. This undoing of chromatic dispersion by sending chromatically dispersed light through a material that has the reverse, or negative, amount of chromatic dispersion that the transmission fiber has is called dispersion compensation.

Dispersion compensation has presented significant technical challenges. For example, the chromatic dispersion induced by telecommunication transmission fibers is often wavelength-dependent. More particularly, chromatic dispersion changes roughly linearly with wavelength over an operational bandwidth, for example, an International Telecommunications Union (ITU) transmission channel, and this chromatic dispersion “slope” often persists over multiple such operational bandwidths. Such fibers may even have a zero-dispersion cross point wavelength whereat chromatic dispersion transitions from negative to positive.

As with correction of chromatic dispersion in general, a common method to correct for chromatic dispersion slope is to reverse its effects. Attempts to correct for chromatic dispersion slope using single-stage dispersion slope compensators have, however, met with certain problems, such as inability to provide an accurate compensating dispersion across multiple operational bandwidths, incurring too much loss, or exacting too high a cost.

### SUMMARY OF THE INVENTION

In one aspect, the present invention provides a pair of chromatic dispersion slope compensators (CDSCs) used in tandem to create a “net CDSC” having a zero-dispersion crosspoint. The CDSCs may have similar compensating dispersion slopes but opposing average compensating dispersions across one or more operational bandwidths. The first CDSC may vary in dispersion from a large positive value to a small positive value across the operational bandwidths, while the second CDSC may vary in dispersion from a small negative value to a large negative value across the operational bandwidths. The CDSCs may be applied in either order to reduce the dispersion slope of chromatically dispersed light received over a transmission fiber. The CDSCs may be Gires-Tournois etalon (GTE) based.

In another aspect, the present invention provides a method for providing a multistage chromatic dispersion slope compensation having a zero-dispersion cross point, wherein the method comprises applying to chromatically dispersed light a first compensating chromatic dispersion varying from a large positive value to a small positive value across one or more operational bandwidths; and applying to the chromatically dispersed light a second compensating dispersion varying from a small negative value to a large negative value across the operational bandwidths. The steps may be applied in either order.

These and other aspects of the invention will be better understood by reference to the following detailed description, taken in conjunction with the accompanying drawings which are briefly described below. Of course, the actual scope of the invention is defined by the appended claims.

### BRIEF DESCRIPTION OF THE DRAWINGS

FIG. 1 shows an optical transmission system including a CDSC pair;

FIG. 2 shows a GTE-based CDSC;

FIG. 3 shows chromatic dispersion induced by the transmission fiber of an optical transmission system as a function of wavelength; and

FIG. 4 shows compensating dispersions applied by a CDSC pair in the optical transmission system as a function of wavelength.

### DETAILED DESCRIPTION OF THE PREFERRED EMBODIMENT

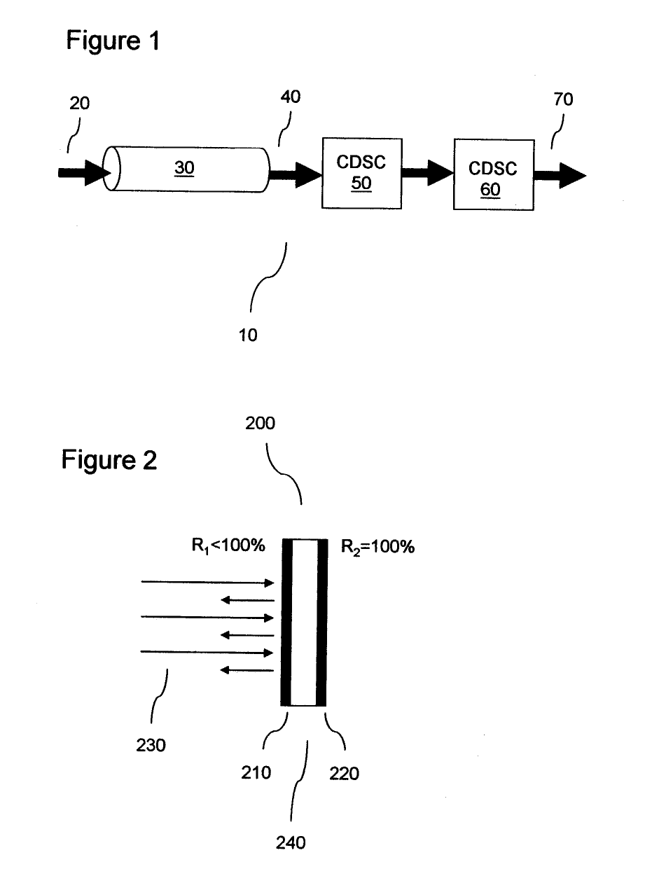

In FIG. 1, an optical transmission system 10 includes a system input 20, a transmission fiber 30, a transmission fiber output 40, a first CDSC 50, a second CDSC 60 and a system output 70, arranged in series. CDSCs 50, 60 are preferably GTE-based. Light pulses within one or more operational bandwidths, such as ITU channels, are applied to system input 20. Upon application to system input 20, the wavelength components of an isolated pulse transmitted on a particular channel are tightly lined up with one another in time, that is, the pulse is “sharp.” Due to the chromatic dispersion induced by transmission fiber 30, however, certain wavelength components travel faster through transmission fiber 30 than other wavelength components. Thus, upon arrival at transmission fiber output 40, the wavelength components of the isolated pulse are chromatically dispersed, and neighboring pulses may interfere with one another. Moreover, the chromatic dispersion induced by transmission fiber 30 is wavelength-dependent, that is, it exhibits a non-zero chromatic dispersion “slope.” The chromatically dispersed light pulses are subjected to first CDSC 50 and second CDSC 60, which in tandem operate to reverse the chromatic dispersion induced by transmission fiber 30 within the one or more operational bandwidths, including reducing or eliminating the chromatic dispersion slope. The re-sharpened pulses are then applied to system output 70.

Turning to FIG. 2, CDSC 200 is shown. CDSC 200 is representative of CDSCs 50, 60. CDSC 200 is a GTE having a first mirror 210 which has a reflectivity R₁ which is less than 100% and a second mirror 220 which has a reflectivity R₂ which is 100%. Chromatically dispersed pulses 230 arriving from, for example, transmission fiber 30 enter and exit CDSC 200 through first mirror 210. CDSC 200 subjects different wavelength components of pulses 230 to variable delay due to its resonant properties. That is, the partial reflectivity of first mirror 210 causes certain wavelength components to be restrained in the glass cavity 240 between first mirror 210 and second mirror 220 longer than others. More particularly, CDSC 200 imposes a wavelength-dependent time delay on the wavelength components of pulses 230 which, when implemented in tandem with its counterpart CDSC, negates the sloped chromatic dispersion induced on pulses 230 by transmission fiber 30. Naturally, etalons are just one example of CDSCs with which the present invention may be implemented. Other CDSCs, such as ring resonators, may be used.

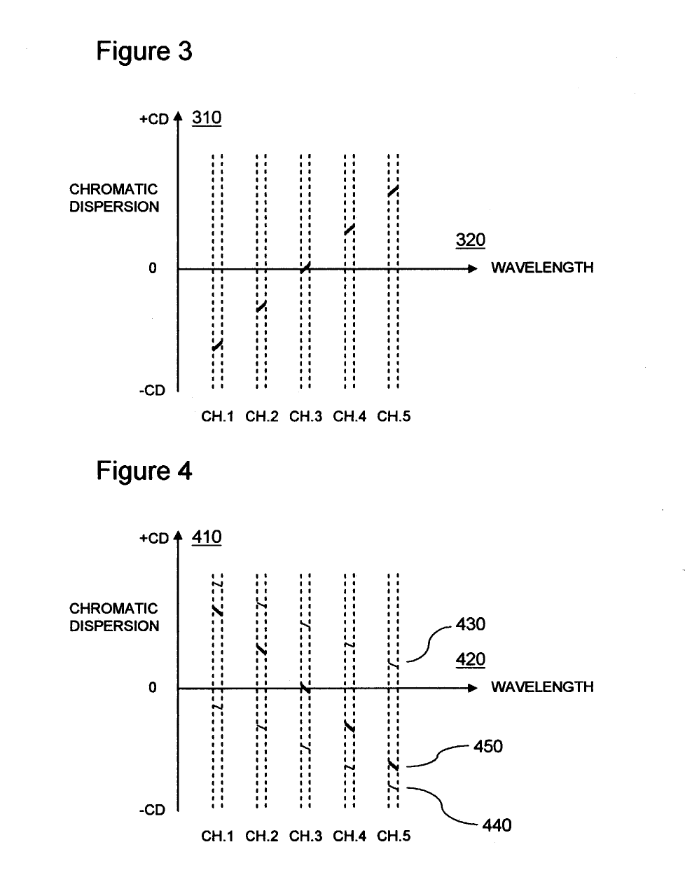

Turning to FIG. 3, the chromatic dispersion induced by transmission fiber 30 is plotted as a function of wavelength for transmission channels 1 through 5, which may be, for example, ITU channels. Transmission channels 1 through 5 reflect operational bandwidths of optical transmission system 10. The chromatic dispersion of fiber 30 is plotted along the vertical axis 310 of the graph while the wavelength components of the light traveling through fiber 30 are plotted along the horizontal axis 320 of the graph. At the short wavelength end of the graph, fiber 30 induces a strong negative chromatic dispersion. Near the center of the plotted wavelength span the chromatic dispersion of fiber 30 passes through zero. At the long wavelength end of the graph, fiber 30 induces a strong positive chromatic dispersion. Moreover, chromatic dispersion increases linearly with wavelength over channels 1 through 5 individually, and this linearity is persistent across the combination of channels as well.

To correct for the chromatic dispersion profile In FIG. 3, a compensating dispersion of the same magnitude but the opposite sign must be applied across the operational bandwidths. Adding the chromatic dispersion of fiber 30 and such compensating dispersion would thus result in a null chromatic dispersion across the operational bandwidths.

Turning now to FIG. 4, such a compensating dispersion applied by the paired CDSCs 50, 60 is plotted. Compensating dispersions are plotted along the vertical axis 410 while wavelength is plotted along the horizontal axis 420. The compensating dispersion is applied in two stages. A first compensating dispersion is applied by first CDSC 50 and is plotted on the graph as 430. This compensating dispersion varies, across the operational bandwidths of channels 1 through 5, from a large positive dispersion at the short wavelength end of the graph to a small positive dispersion at the long wavelength end of the graph. A second compensating dispersion is applied by second CDSC 60 and is plotted on the graph as 440. This compensating dispersion varies, across the operational bandwidths of channels 1 through 5, from a small negative dispersion at the short wavelength end of the graph to large negative dispersion at the long wavelength end of the graph. The compensating dispersions applied in the two stages together result in a net compensating dispersion 450 which varies from a large positive value to a large negative value across the operational bandwidths. This net compensating dispersion 450 effectively “zeroes out” the chromatic dispersion of fiber 30.

It will be appreciated by those of ordinary skill in the art that the invention can be embodied in other specific forms without departing from the spirit or essential character hereof. For example, rather than eliminating chromatic dispersion induced by fiber 30, it may be desirable in certain applications to retain some chromatic dispersion slope across one or more operational bandwidths. The present invention is therefore considered in all respects illustrative and not restrictive. The scope of the invention is indicated by the appended claims, and all changes that come within the meaning and range of equivalents thereof are intended to be embraced therein.

We claim:

1. A chromatic dispersion slope compensation system, comprising:
a first chromatic dispersion slope compensator having a first dispersion profile which varies from a first positive value to a second positive value over one or more operational bandwidths; and
a second chromatic dispersion slope compensator having a second dispersion profile which varies from a first negative value to a second negative value over the one or more operational bandwidths;
wherein the first and second chromatic dispersion slope compensators are applied to reduce the dispersion slope of light.

2. The system of claim 1, wherein the sum of the first and second dispersion profiles is a third dispersion profile which varies from a third positive value to a third negative value over the one or more operational bandwidths.

3. The system of claim 2, wherein prior to the application of the first and second chromatic dispersion slope compensators the light has a fourth dispersion profile which varies from a fourth negative value to a fourth positive value over the one or more operational bandwidths.

4. The system of claim 1, wherein the first positive value is associated with a shorter wavelength than the second positive value, and is greater than the second positive value.

5. The system of claim 1, wherein the first negative value is associated with a shorter bandwidth than the second negative value, and is greater than the second negative value.

6. The system of claim 1, wherein the first chromatic dispersion slope compensator is applied to the light before the second chromatic dispersion slope compensator.

7. The system of claim 1, wherein the first chromatic dispersion slope compensator is applied to the light after the second chromatic dispersion slope compensator.

8. The system of claim 1, wherein the first and second chromatic dispersion slope compensators are etalon-based.

9. The system of claim 1, wherein each of the one or more operational bandwidths is an ITU transmission channel.

10. The system of claim 1, wherein the one or more operational bandwidths include a plurality of operational bandwidths each of which is an ITU transmission channel.

11. A method for providing a multistage chromatic dispersion slope compensation to reduce the dispersion slope of light, comprising the steps of:
applying to the light a first compensating dispersion varying from a first positive value to a second positive value across one or more operational bandwidths; and
applying to the light a second compensating dispersion varying from a first negative value to a second negative value across the one or more operational bandwidths.

12. The method of claim 11, wherein the sum of the first and second compensating dispersions is a third compensating dispersion which varies from a third positive value to a third negative value over the one or more operational bandwidths.

13. The method of claim 12, wherein prior to the application of the first and second compensating dispersions the light has a fourth dispersion profile which varies from a fourth negative value to a fourth positive value over the one or more operational bandwidths.

14. The method of claim 11, wherein the first positive value is associated with a shorter wavelength than the second positive value, and is greater than the second positive value.

15. The method of claim 11, wherein the first negative value is associated with a shorter bandwidth than the second negative value, and is greater than the second negative value.

16. The method of claim 11, wherein the first applying step occurs before the second applying step.

17. The method of claim 11, wherein the second applying step occurs before the first applying step.

18. The method of claim 11, wherein the first and second applying steps are performed using etalon-based chromatic dispersion slope compensators.

19. The method of claim 11, wherein each of the one or more operational bandwidths is an ITU transmission channel.

20. The method of claim 11, wherein the one or more operational bandwidths include a plurality of operational bandwidths each of which is an ITU transmission channel.

21. A chromatic dispersion slope compensation system, comprising:
a multiple of chromatic dispersion slope compensators having a multiple of dispersion profiles, respectively, over one or more operational bandwidths,
wherein the sum of the multiple of dispersion profiles is a net dispersion profile having a zero dispersion crosspoint, and
wherein the multiple of chromatic dispersion slope compensators are applied to reduce the dispersion slope of light over the one or more operational bandwidths.

22. The system of claim 21, wherein the net dispersion profile varies from a positive value to a negative value.

23. The system of claim 21, wherein the multiple of chromatic dispersion slope compensators are etalon-based.

24. The system of claim 21, wherein each of the one or more operational bandwidths is an ITU transmission channel.

25. The system of claim 21, wherein the one or more operational bandwidths include a plurality of operational bandwidths each of which is an ITU transmission channel.
